(19) United States
(12) Patent Application Publication
(10) Pub. No.: US 2004/0174693 A1
(43) Pub. Date: Sep. 9, 2004

(54) Light guide plate for liquid crystal display

(76) Inventors: Ga-Lane Chen, Fremont, CA (US); Charles Leu, Fremont, CA (US); Tai-Cheng Yu, Tu-Chen (TW)

Correspondence Address: WEI TE CHUNG, FOXCONN INTERNATIONAL, INC., 1650 MEMOREX DRIVE, SANTA CLARA, CA, 95050, US

(21) Appl. No.: 10/658,015

(22) Filed: Sep. 8, 2003

(30) Foreign Application Priority Data
Feb. 27, 2003 (TW) 92104337

(51) Int. Cl. G02B 6/18

(52) U.S. Cl. 362/24; 264/1.24

(57) ABSTRACT

The present invention provides a light guide plate for liquid crystal displays. The light guide plate is made from a cyclic olefin copolymer (COC) material, which is represented by the formula:

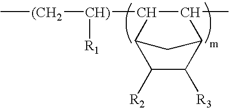

wherein each of R₁, R₂ and R₃ is independently selected from the groups consisting of hydrogen and aliphatic saturated groups, and m is an integer which is equal to or greater than 1. The COC material is an amorphous and transparent copolymer, and is synthesized by alpha-olefin monomers and cycloolefin monomers in a catalyst of metallocene or a catalyst of π complex compound.

### BACKGROUND OF THE INVENTION

1. Field of the Invention

The present invention relates to a device for use with a liquid crystal display, and more particularly to a light guide plate for use with a liquid crystal display.

2. Description of Prior Art

A back light system of a liquid crystal display generally comprises a light source, a light guide plate, a prism plate, a diffusion plate and a reflection plate. The light guide plate is the most important component in the back light system.

Currently, light guide plates are generally made using molded methods. A light guide plate is first molded into a wedge. Then a material having a high reflectivity is attached in a pattern to a surface of the light guide plate. The pattern generally, comprises circular or square shaped diffusion points, which are formed on the surface of the light guide plate. Light guide plates are typically made of polycarbonate (PC) or polymethyl methacrylate (PMMA).

Characteristics valuable in a light guide plate include a high light transmittance, a minimized thickness, and a minimized distortion due to moisture absorption. However, moisture absorption by both PC and PMMA is high, such that performance of a light guide plates made of those materials is bad. Furthermore, performance of a light guide plates is easily affected by variations in the environment.

Therefore, a light guide plate which has low moisture absorption and reliable performance is desired.

### SUMMARY OF THE INVENTION

Accordingly, an object of the present invention is to provide a light guide plate which has low moisture absorption and reliable performance.

In order to achieve the object set forth above, the present invention provides a light guide plate for liquid crystal displays. The light guide plate is made of a cyclic olefin copolymer (COC) material, which is represented by the formula:

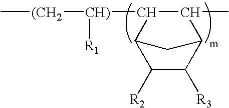

wherein each of R₁, R₂ and R₃ is independently selected from the groups consisting of hydrogen and aliphatic saturated groups, and m is an integer which is equal to or greater than 1.

The COC material is an amorphous and transparent copolymer, and is synthesized by alpha-olefin monomers and cycloolefin monomers in a catalyst of metallocene or in a catalyst of π complex compound.

Other objects, advantages and novel features of the present invention will become more apparent from the following detailed description when taken in conjunction with the accompanying drawings, in which:

### BRIEF DESCRIPTION OF THE DRAWINGS

FIG. 1 is a graph of environmental durability of polycarbonate, polymethyl methacrylate and cyclic olefin copolymer materials; and

FIG. 2 is a graph of thermal stability of polycarbonate, polymethyl methacrylate and cyclic olefin copolymer materials.

### DETAILED DESCRIPTION OF PREFERRED EMBODIMENT OF THE INVENTION

A light guide plate of the present invention is used for a liquid crystal display. The light guide plate is made of a cyclic olefin copolymer (COC) material, which is an amorphous and transparent copolymer. The COC material is synthesized using alpha-olefin monomers and cycloolefin monomers in a catalyst of metallocene or in a catalyst of π complex compound. The synthesizing equation is:

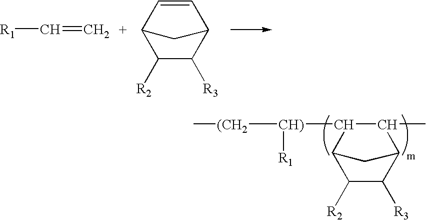

wherein each of R₁, R₂ and R₃ is independently selected from the groups consisting of hydrogen and aliphatic saturated groups, and m is an integer which is equal to or greater than 1.

The COC material is prior art and is polymerized at a temperature in the range from minus 78 to 200 degrees Centigrade, and at a pressure in the range from 0.5 to 70 Pa. Preferably, the COC material is polymerized at a temperature in the range from minus 50 to 150 degrees Centigrade, and at a pressure in the range from 1 to 50 Pa. Furthermore, a molar ratio of said monomers to metallocene or π complex compound is in the range from 10¹ to 10¹².

The COC material used in the light guide plate of the present invention has the following properties:

(1) high glass transition temperature;

(2) high light transmittance; and

(3) reliable heat stability.

Those properties are discussed in greater detail below.

The stiffness of main chains of the COC material is high, therefore the COC material has a high glass transition temperature (80 to 185 degrees Centigrade). Furthermore, the glass transition temperature of the COC material may be varied according to the content of reacting cycloolefin.

The COC material does not have unpaired π electrons or chromatic functional groups, so the COC material has high light transmittance (>92%) for light beams of 300 to 1,000 nanometers wavelength. Furthermore, the COC material does not have double bonds, triple bonds or aromatic rings. Therefore oxidation resistance properties of the COC material are excellent, and its temperature of thermal degradation is about 400 degrees Centigrade or more.

Referring to the following table, a density of the COC material is 1.01 g/cm³. Therefore a light guide plate made of the COC material is lighter than one made of PC or PMMA. Furthermore, water absorption and a stress optical coefficient of the COC material are both lower than those of PC and PMMA. Accordingly, a light guide plate made of the COC material has more reliable properties.

| Property | COC | PC | PMMA |
|---|---|---|---|
| Density, g/cm³ | 1.01 | 1.2 | 1.2 |
| Water Absorption, % | 0.01 | 0.04 | 0.1 |
| Light Transmittance, % | 92 | 88 | 92 |
| Stress Optical Coefficient, 10¹² Pa/s | 4.0 | 68 | 4.6 |

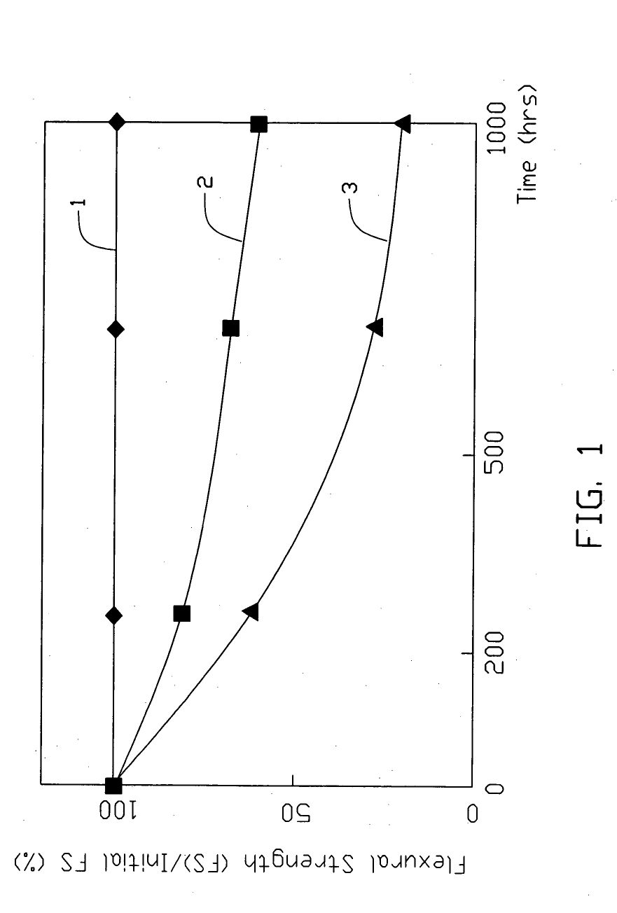

Referring to FIG. 1, curve 1 indicates that the flexible strength of the COC material remains substantially undiminished when it is subjected to a temperature of 80 degrees Centigrade at 100% relative humidity for 1000 hours or when it is subjected to a temperature of 120 degrees Centigrade in a dry environment for 1000 hours. Curve 2 indicates that the flexible strength of PC is reduced by about 25% when it is subjected to a temperature of 120 degrees Centigrade in a dry environment for 1000 hours. Curve 3 indicates that the flexible strength of PMMA is reduced by about 75% when it is subjected to a temperature of 80 degrees Centigrade at 100% relative humidity for 1000 hours. In view of the forgoing, a light guide plate made of the COC material is more reliable than a light guide plate made of PC or PMMA.

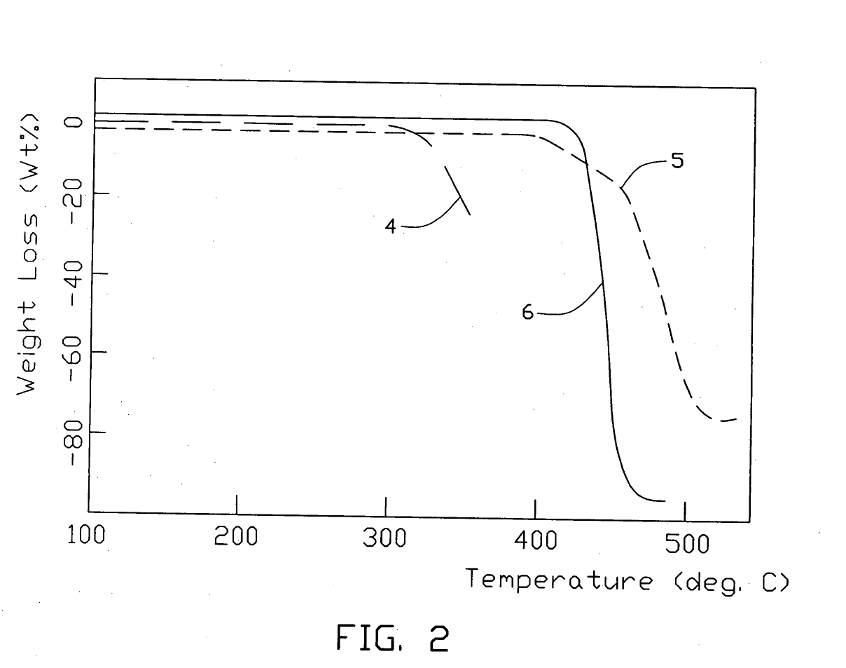

Referring to FIG. 2, curve 4 indicates that PMMA degrades at a temperature of 300 degrees Centigrade in argon gas at a heating rate of 10 deg. Centigrade/minute. Curve 5 indicates that PC degrades at a temperature of 400 degrees Centigrade in argon gas at a heating rate of 10 deg. Centigrade/minute. Curve 6 indicates that the COC material degrades at a temperature slightly above 400 degrees Centigrade in argon gas at a heating rate of 10 deg. Centigrade/minute. Accordingly, the COC material has the best thermal stability, and is most suitable for use in light guide plates than PC and PMMA.

It is understood that the invention may be embodied in other forms without departing from the spirit thereof. Thus, the present examples and embodiments are to be considered in all respects as illustrative and not restrictive, and the invention is not to be limited to the details given herein.

What is claimed is:

1. A light guide plate for liquid crystal displays comprising a cyclic olefin copolymer material, the cyclic olefin copolymer material being represented by the formula: 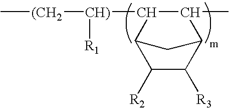
wherein each of R₁, R₂ and R₃ is independently selected from the groups consisting of hydrogen and aliphatic saturated groups, and m is an integer which is equal to or greater than 1.

2. The light guide plate in accordance with claim 1, wherein the cyclic olefin copolymer material is a copolymer of alpha-olefin monomers and cycloolefin monomers.

3. The light guide plate in accordance with claim 2, wherein the cyclic olefin copolymer material is polymerized at a temperature between minus 78 to 200 degrees Centigrade and at a pressure from 0.5 to 70 Pa.

4. The light guide plate in accordance with claim 3, wherein the cyclic olefin copolymer material is polymerized in a catalyst of metallocene.

5. The light guide plate in accordance with claim 4, wherein a molar ratio of said monomers to the metallocene catalyst is in the range of 10¹ to 10¹².

6. The light guide plate in accordance with claim 3, wherein the temperature is preferably from minus 50 to 150 degrees Centigrade.

7. The light guide plate in accordance with claim 3, wherein the pressure is preferably from 1 to 50 Pa.

8. The light guide plate in accordance with claim 3, wherein the cyclic olefin copolymer material is polymerized in a catalyst of π complex compound catalyst.

9. The light guide plate in accordance with claim 8, wherein a molar ratio of said monomers to the π complex compound catalyst is in the range of 10¹ to 10¹².

10. A method of making a light guide plate for a liquid crystal display, comprising a step of providing the light guide plate which is made of a cyclic olefin copolymer material, the cyclic olefin copolymer material being represented by the formula: 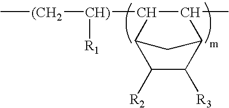
wherein each of R₁, R₂ and R₃ is independently selected from the groups consisting of hydrogen and aliphatic saturated groups, and m is an integer which is equal to or greater than 1, and wherein diffusion points are formed on a surface of said light guide plate.
